(19) United States
(12) Patent Application Publication
(10) Pub. No.: US 2013/0013756 A1
(43) Pub. Date: Jan. 10, 2013

(54) NETWORK UNIT REPLACING METHOD FOR EMBEDDED SYSTEM DEVICE HAVING INTERNAL NETWORK UNIT AND EMBEDDED SYSTEM DEVICE

(76) Inventors: Chun-Nan Lin, Yilan County (TW); Chin-Yi Lin, Hsinchu County (TW); Chih-Hsiang Ho, Hsinchu County (TW); Chien-Tao Wang, Hsinchu County (TW)

(21) Appl. No.: 13/462,831

(22) Filed: May 3, 2012

(30) Foreign Application Priority Data
Jul. 4, 2011 (TW) 100123529

(51) Int. Cl. G06F 15/177

(52) U.S. Cl. 709/222

(57) ABSTRACT

The present invention provides a network unit replacing method for an embedded system device having an internal network unit and a related embedded system device. The network unit replacing method comprises: detecting a network unit type of the embedded system device, to generate a detecting result; and when the detecting result indicates that the embedded system device has at least an external network unit currently, initializing the external network unit to make the embedded system device access network via the external network unit instead of the internal network unit.

### BACKGROUND OF THE INVENTION

1. Field of the Invention

The present invention relates to a network unit replacing method and an embedded system device, and more particularly, to a network unit replacing method for an embedded system device having an internal network unit and a related embedded system device.

2. Description of the Prior Art

In general, a network unit of a conventional embedded system device (such a TV or a multi-media playing device) is an internal network unit (a wireless network interface card or a cable network interface card). When the internal network unit of the embedded system device can not operate normally and requires repair, the conventional repairing method is dismantle the embedded system device to dismount the internal network unit, and then install a new internal network unit in the embedded system device. However, this method costs a lot of human powers and time, and thus causes high repairing cost and low repairing efficiency.

### SUMMARY OF THE INVENTION

It is therefore one of the objectives of the present invention to provide a network unit replacing method for an embedded system device having an internal network unit and an embedded system device, so as to solve the above problem.

In accordance with an embodiment of the present invention, a network unit replacing method for an embedded system device having an internal network unit is disclosed. The network unit replacing method comprises: detecting a network unit type of the embedded system device, to generate a detecting result; and when the detecting result indicates that the embedded system device has at least an external network unit currently, initializing the external network unit to make the embedded system device access network via the external network unit instead of the internal network unit.

In accordance with an embodiment of the present invention, an embedded system device is disclosed. The embedded system device comprises: an internal network unit, a detecting unit, and a processing unit. The detecting unit is utilized for detecting a network unit type of the embedded system device, to generate a detecting result. The processing unit is coupled to the detecting unit, and utilized for initializing the external network unit to make the embedded system device access network via the external network unit instead of the internal network unit when the detecting result indicates that the embedded system device has at least an external network unit currently.

Briefly summarized, the network unit replacing method for an embedded system device having an internal network unit and a related embedded system device disclosed by the present invention can use an external network unit to replace the internal network unit rapidly and correctly. Thus, when the internal network unit of the embedded system device can not operate normally and requires repair, the present invention can save human powers and time cost of the conventional repairing scheme. The present invention electrically connects a normally operating external network unit to the embedded system device (such as via a USB interface) to save human powers and time, so as to reduce repairing cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an embedded system device according to an embodiment of the present invention.

FIG. 2 shows an exemplary flowchart of the present invention showing a network unit replacing method for an embedded system device having an internal network unit in accordance with the operations of the embedded system in FIG. 1.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

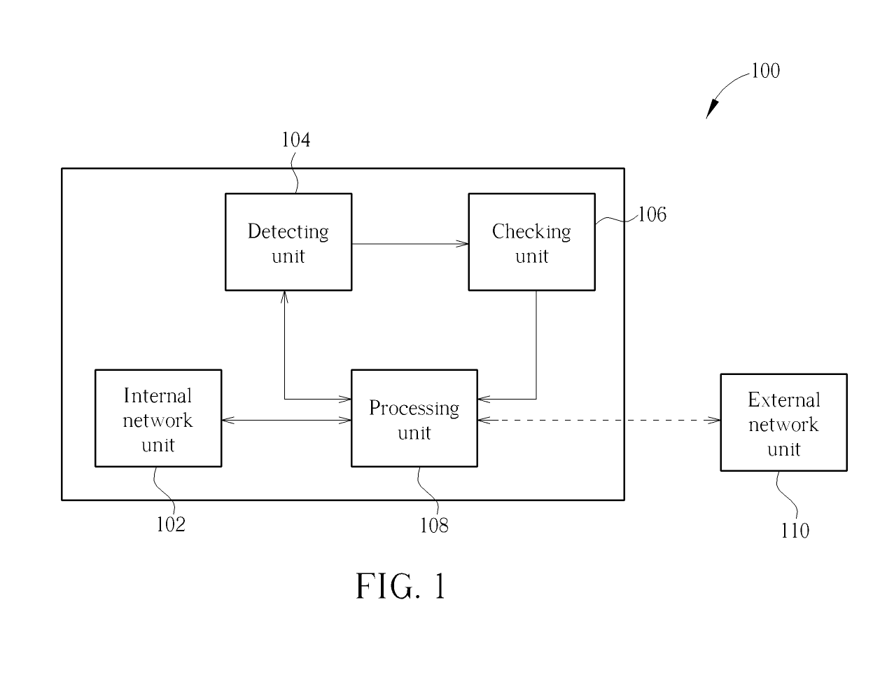

Please refer to FIG. 1. FIG. 1 is an embedded system device 100 according to an embodiment of the present invention, wherein the embedded system device 100 can be a TV or a multi-media playing device. As shown in FIG. 1, the embedded system device 100 comprises: an internal network unit 102, a detecting unit 104, a checking unit 106, and a processing unit 108. The detecting unit 104 is utilized for detecting a network unit type of the embedded system device 100, to generate a detecting result. The internal network unit 102 can have a memory address for recording the characteristic (internally connecting or externally connecting) thereof, and the internal network unit 102 can be a wireless network interface card or a cable network interface card.

When the detecting result indicates that the embedded system device has an external network unit 110 currently (the external network unit 110 also can have a memory address for recording the characteristic (internally connecting or externally connecting) thereof, and the external network unit 110 can be a wireless network interface card or a cable network interface card). The checking unit 106 is utilized for checking whether a network unit name wlan0 which the external network unit 110 expects to use has been used, to generate a checking result. If the checking unit 106 checks that the network unit name wlan0 has been used, the processing unit 108 will obtain sharing information of the internal network unit 102 and other elements of the embedded system device100, and releases resources used by the internal network unit 102 of the embedded system device100, and initializes the external network unit 110. Otherwise, if the network unit name wlan0 has not been used, the processing unit 108 directly initializes the external network unit 110 to make the embedded system device 100 access network via the external network unit 110 instead of the internal network unit 102. In other words, when the detecting result indicates that the embedded system device 100 has an external network unit 110 currently, the processing unit 108 will initialize the external network unit 110 to make the embedded system device 100 access network via the external network unit 110, and the processing unit 108 initializes the external network unit 110 according to the checking result.

Moreover, when the detecting result indicates that the embedded system device 100 only has the internal network unit 102 currently, the processing unit 108 will initialize the internal network unit 102 to make the embedded system 100 access network via the internal network unit 102. Please note that the above embodiment is only for an illustrative purpose and is not meant to be a limitation of the present invention.

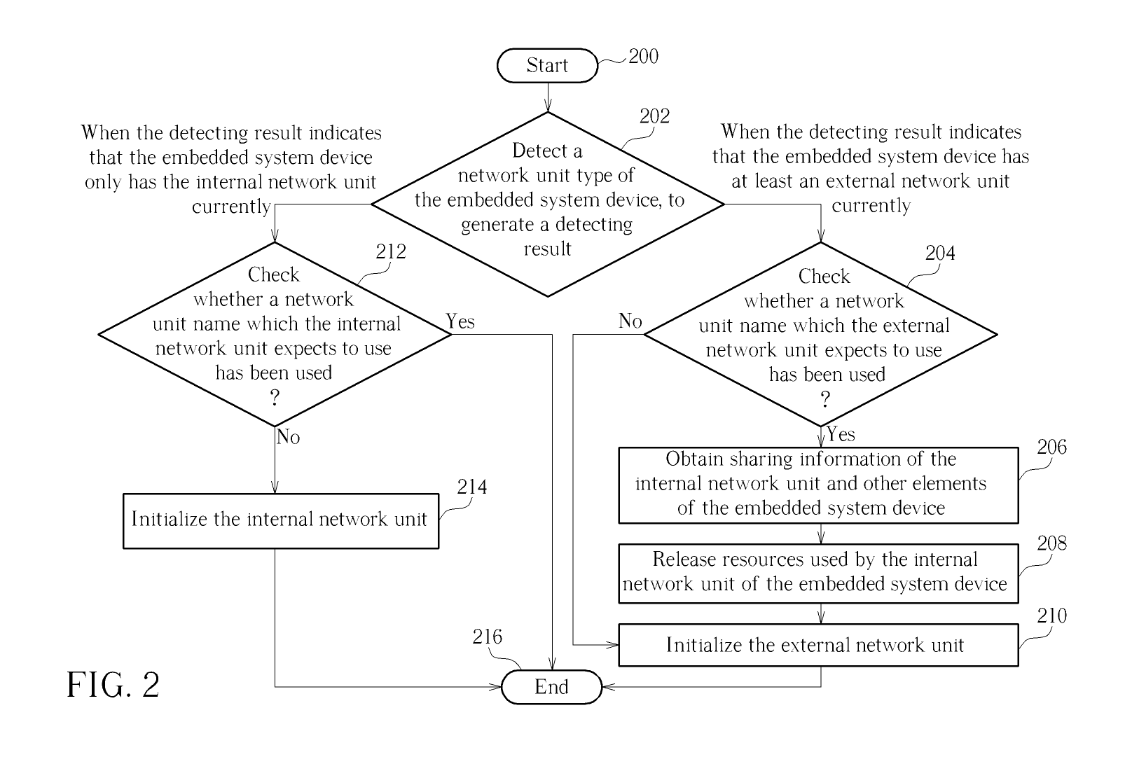

Please refer to FIG. 2. FIG. 2 shows an exemplary flowchart of the present invention showing a network unit replacing method for an embedded system device having an internal network unit in accordance with the above operations of the embedded system 100. Provided that substantially the same result is achieved, the steps of the process flowchart do not have to be in the exact order shown in FIG. 4 and need not be contiguous, meaning that other steps can be intermediate. The method of the disclosure comprises the following steps:

Step 200: Start.

Step 202: Detect a network unit type of the embedded system device, to generate a detecting result; when the detecting result indicates that the embedded system device has at least an external network unit currently, perform Step 204; when the detecting result indicates that the embedded system device only has the internal network unit currently, perform Step 212.

Step 204: Check whether a network unit name which the external network unit expects to use has been used; if the network unit name has been used, perform Step 206; if the network unit name has not been used, perform Step 210.

Step 206: Obtain sharing information of the internal network unit and other elements of the embedded system device.

Step 208: Release resources used by the internal network unit of the embedded system device.

Step 210: Initialize the external network unit, and perform Step 216.

Step 212: Check whether a network unit name which the internal network unit expects to use has been used; if the network unit name has been used, perform Step 216; if the network unit name has not been used, perform Step 214.

Step 214: Initialize the internal network unit, and perform Step 216.

Step 216: End.

Briefly summarized, the network unit replacing method for an embedded system device having an internal network unit and a related embedded system device disclosed by the present invention can use an external network unit to replace the internal network unit rapidly and correctly. Thus, when the internal network unit of the embedded system device can not operate normally and requires repair, the present invention can save human powers and time cost of the conventional repairing scheme. The present invention electrically connects a normally operating external network unit to the embedded system device (such as via a USB interface) to save human powers and time, so as to reduce repairing cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network unit replacing method for an embedded system device having an internal network unit, comprising:
detecting a network unit type of the embedded system device, to generate a detecting result; and
when the detecting result indicates that the embedded system device has at least an external network unit currently, initializing the external network unit to make the embedded system device access network via the external network unit instead of the internal network unit.

2. The network unit replacing method of claim 1, wherein the step of initializing the external network unit comprises:
checking whether a network unit name which the external network unit expects to use has been used, to generate a checking result; and
initializing the external network unit according to the checking result.

3. The network unit replacing method of claim 2, wherein the step of initializing the external network unit according to the checking result comprises:
if the network unit name has been used, obtaining sharing information of the internal network unit and other elements of the embedded system device, releasing resources used by the internal network unit of the embedded system device, and initializing the external network unit.

4. The network unit replacing method of claim 2, wherein the step of initializing the external network unit according to the checking result comprises:
if the network unit name has not been used, directly initializing the external network unit.

5. The network unit replacing method of claim 1, further comprising:
when the detecting result indicates that the embedded system device only has the internal network unit currently, initializing the internal network unit to make the embedded system device access network via the internal network unit.

6. An embedded system device, comprising:
an internal network unit;
a detecting unit, for detecting a network unit type of the embedded system device, to generate a detecting result; and
a processing unit, coupled to the detecting unit, for initializing the external network unit to make the embedded system device access network via the external network unit instead of the internal network unit when the detecting result indicates that the embedded system device has at least an external network unit currently.

7. The embedded system device of claim 6, further comprising:
a checking unit, coupled to the detecting unit, for checking whether a network unit name which the external network unit expects to use has been used, to generate a checking result;
wherein the processing unit initializes the external network unit according to the checking result.

8. The embedded system device of claim 7, wherein the processing unit's function of initializing the external network unit according to the checking result comprises:
if the checking unit checks that the network unit name has been used, the processing unit obtains sharing information of the internal network unit and other elements of the embedded system device, and releases resources used by the internal network unit of the embedded system device, and initializes the external network unit.

9. The embedded system device of claim 7, wherein the processing unit's function of initializing the external network unit according to the checking result comprises:
if the checking unit checks that the network unit name has not been used, the processing unit directly initializes the external network unit.

10. The embedded system device of claim 6, wherein when the detecting result indicates that the embedded system device only has the internal network unit currently, the processing unit initializes the internal network unit to make the embedded system access network via the internal network unit.

11. The embedded system device of claim 6, wherein the embedded system device is a TV or a multi-media playing device.

12. The embedded system device of claim 6, wherein the internal network unit and the external network respectively has a memory address for recording characteristics thereof.
